(19) United States
(12) Patent Application Publication
(10) Pub. No.: US 2026/0312664 A1
(43) Pub. Date: Oct. 8, 2026

(54) PROBING BEAM PROCEDURE

(71) Applicant: Telefonaktiebolaget LM Ericsson (publ), Stockholm (SE)

(72) Inventors: Jianwei Zhang, Solna (SE); Jing Rao, Sollentuna (SE); Andreas Nilsson, Göteborg (SE); Sven Jacobsson, Västra Frölunda (SE); Siva Muruganathan, Stittsville, Ontario (CA); Lei Bao, Göteborg (SE)

(21) Appl. No.: 19/481,386

(22) PCT Filed: May 6, 2024
(86) PCT No.: PCT/EP2024/062436

§ 371 Date: Nov. 4, 2025

Related U.S. Application Data
(60) Provisional application No. 63/464,366, filed on May 5, 2023.

(51) Int. Cl. H04B 7/06; H04B 7/0404; H04L 5/00

(52) U.S. Cl. CPC H04B 7/0696; H04B 7/0404; H04B 7/0628; H04B 7/06966; H04L 5/0048

(57) ABSTRACT

Systems and methods of a probing beam procedure are provided. In some embodiments, a method performed by a User Equipment (UE) for evaluating candidate beam pair links includes: indicating support for probing Uplink (UL) Reference Signal (RS) during capability signaling; determining a spatial filter for a UL-RS transmission based on one or more Downlink (DL) Reference Signals (DL-RSs); updating the spatial relation of a UL-RS; and transmitting UL-RS directly without a need of explicit spatial relation update for the UL-RS from a network node. In this way, some embodiments enable the network to evaluate candidate beam pair links based on a UL-RS transmission of a UE, without the need to explicitly indicate spatial filter that the UE shall use for the UL-RS transmission. Some embodiments describe several solutions on how to perform the methods with reduced UL-RS overhead by letting the UE help when to trigger the UL-RS transmission.

### RELATED APPLICATIONS

This application claims the benefit of provisional patent application Ser. No. 63/464,366, filed May 5, 2023, the disclosure of which is hereby incorporated herein by reference in its entirety.

### TECHNICAL FIELD

The current disclosure relates generally to evaluating candidate beam pair links.

### BACKGROUND

### Beam Determination and Indication Procedure in NR

In New Radio (NR) typical beam determination procedures include implicit procedure that uses Synchronization Signal Block (SSB) beam associated with initial access, and explicit beam activation that uses MAC CE and DCI based beam indication. The word “beam” is not commonly used in NR specification, instead TCI state for UL and DL, spatial information for UL and QCL association are the tools to describe beam related behaviour.

In initial access procedure, UE sending PRACH associated with a selected SSB beam for corresponding beam direction toward gNB after UE has done selection based on measurement on detected SSB beams. At receiving the PRACH from the UE, gNB knows the SSB beam UE has selected to monitor and transmits in downlink the random-access response (Msg2) to the UE. UE uses the selected beam to transmit Msg3 in a contention-based procedure. After initial access, if only one TCI state is sufficient, UE will use the SSB beam selected in initial access as connected beam.

For gNB to switch UE to beams other than the SSB beam selected after initial access, explicit beam indication procedure is used. The gNB configures and sends multiple beams via SSB for UE to measure; UE connected to the network measures the L1-Reference Signal Received Power (RSRP) of the SSB beams and reports in beam report the strongest beams in a CSI report in the uplink, this CSI report can be carried on PUCCH or PUSCH. At receiving the L1-RSRP report in CSI report, gNB sends MAC CE to update the active TCI state associated with the reported beam(s) from the latest CSI report. After the activation via MAC CE is confirmed by UE, the gNB may trigger further beam refinement procedure (P2) to let the UE measure the finer CSI-RS beam associated with the activated TCI state and report the L1-RSRP for finer CSI-RS beams or let UE to send SRS in the uplink. Once a refined beam is selected, gNB sends beam indication signal to the UE. The beam indication signal can be carried on DCI or MAC CE.

As used herein, the beam that is known to both UE and network side, which is used for data and information exchange between network and UE, is referred to as the “connected” beam. The “connected beam” is used for DL and UL transmission involving channels such as PDCCH/PDSCH/PUCCH/PUSCH and reference signal DM-RS/SRS/CSI-RS. A beam becomes a connected beam after implicit or explicit procedure where implicit procedure referring to initial access procedure and explicit procedure referring to beam activation and indication via MAC CE and/or DCI.

Beam indication via spatial QCL

In NR, several signals can be transmitted from different antenna ports of a same base station. These signals can have the same large-scale properties such as Doppler shift/spread, average delay spread, or average delay. These antenna ports are then said to be quasi co-located (QCL).

If the UE knows that two antenna ports are QCL with respect to a certain parameter (e.g., Doppler spread), the UE can estimate that parameter based on one of the antenna ports and apply that estimate for receiving signal on the other antenna port.

For example, there may be a QCL relation between a CSI-RS for tracking RS (TRS) and the PDSCH DMRS. When UE receives the PDSCH DMRS it can use the measurements already made on the TRS to assist the DMRS reception.

Information about what assumptions can be made regarding QCL is signaled to the UE from the network. In NR, four types of QCL relations between a transmitted source RS and transmitted target RS were defined:

Type A: {Doppler shift, Doppler spread, average delay, delay spread}
Type B: {Doppler shift, Doppler spread}
Type C: {average delay, Doppler shift}
Type D: {Spatial Rx parameter}

QCL type D was introduced in NR to facilitate beam management with analog beamforming and is known as spatial QCL. There is currently no strict definition of spatial QCL, but the understanding is that if two transmitted antenna ports are spatially QCL, the UE can use the same Rx beam to receive them. This is helpful for a UE that uses analog beamforming to receive signals, since the UE needs to adjust its RX beam in some direction prior to receiving a certain signal. If the UE knows that the signal is spatially QCL with some other signal it has received earlier, then it can safely use the same RX beam to also receive this signal.

In the uplink the term spatial relation is used. If an UL signal/channel is spatially related to a DL signal, it means the UL signal/channel can be transmitted with the same spatial filter that was used to receive the DL signal. If an UL signal/channel is spatially related to a second UL signal, it means the UL signal/channel can be transmitted with the same spatial filter that was used to transmit the second UL signal.

In NR, the spatial relation for a DL or UL signal/channel can be indicated to the UE by using a “beam indication”. The “beam indication” is used to help the UE to find a suitable RX beam for DL reception, and/or a suitable TX beam for UL transmission. In NR, the “beam indication” for DL is conveyed to the UE by indicating a transmission configuration indicator (TCI) state to the UE, while in UL the “beam indication” can be conveyed by indicating a DL-RS or UL-RS as spatial relation (in NR Rel-15/16) or a TCI state (in NR rel-17).

### Sounding Reference Signal (SRS)

In NR, SRS is used for providing CSI to the gNB in the UL. The usage of SRS includes, e.g., deriving the appropriate transmission/reception beams and/or to perform link adaptation (i.e., setting the transmission rank and the MCS), and for selecting DL (e.g., for PDSCH transmissions) and UL (e.g., for PUSCH transmissions) MIMO precoding.

In LTE and NR, the SRS is configured via RRC, where parts of the configuration can be updated (for reduced latency) through MAC CE signaling. The configuration includes, for example, the SRS resource allocation (the physical mapping and the sequence to use) as well as the time-domain behavior (aperiodic, semi-persistent, or periodic). For aperiodic SRS transmission, the RRC configuration does not activate an SRS transmission from the UE but instead a dynamic activation trigger is transmitted from the gNB in the DL, via the DCI in the PDCCH which instructs the UE to transmit the SRS once, at a predetermined time.

When configuring SRS transmissions, the gNB configures, through the SRS-Config 1E, a set of SRS resources and a set of SRS resource sets, where each SRS resource set contains one or more SRS resources.

Each SRS resource is configured with the following in RRC (see ASN code in 3GPP TS 38.331).

| SRS-Resource ::= | SEQUENCE { |
|---|---|
| srs-ResourceId | SRS-ResourceId, |
| nrofSRS-Ports | ENUMERATED {port1, |
| ports2, ports4}, | |
| ptrs-PortIndex | ENUMERATED {n0, n1 } |
| OPTIONAL, -- Need R | |
| transmissionComb | CHOICE { |
| n2 | SEQUENCE { |
| combOffset-n2 | INTEGER |
| (0..1), | |
| cyclicShift-n2 | INTEGER |
| (0..7) | |
| }, | |
| n4 | SEQUENCE { |
| combOffset-n4 | INTEGER |
| (0..3), | |
| cyclicShift-n4 | INTEGER |
| (0..11) | |
| } | |
| }, | |
| resourceMapping | SEQUENCE { |
| startPosition | INTEGER (0..5), |
| nrofSymbols | ENUMERATED {n1, |
| n2, n4}, | |
| repetitionFactor | ENUMERATED {n1, |
| n2, n4} | |
| }, | |
| freqDomainPosition | INTEGER (0..67), |
| freqDomainShift | INTEGER (0..268), |
| freqHopping | SEQUENCE { |
| c-SRS | INTEGER (0..63), |
| b-SRS | INTEGER (0..3), |
| b-hop | INTEGER (0..3) |
| }, | |
| groupOrSequenceHopping | ENUMERATED { |
| neither, groupHopping, sequenceHopping }, | |
| resourceType | CHOICE { |
| aperiodic | SEQUENCE { |
| ... | |
| }, | |
| semi-persistent | SEQUENCE { |
| periodicityAndOffset-sp | SRS- |
| PeriodicityAndOffset, | |
| ... | |
| }, | |
| periodic | SEQUENCE { |
| periodicityAndOffset-p | SRS- |
| PeriodicityAndOffset, | |
| ... | |
| } | |
| }, | |
| sequenceId | INTEGER (0..1023), |
| spatialRelationInfo | SRS- |
| SpatialRelationInfo OPTIONAL, -- Need R | |
| ... | |
| [[ | |
| resourceMapping-r16 | SEQUENCE { |
| startPosition-r16 | INTEGER (0..13), |
| nrofSymbols-r16 | ENUMERATED {n1, |
| n2, n4}, | |
| repetitionFactor-r16 | ENUMERATED {n1, |
| n2, n4} | |
| } | OPTIONAL -- |

Need R
]]
}

An SRS resource is configurable with respect to, e.g.,
1) The number of SRS ports (1, 2, or 4), configured by the RRC parameter nrofSRS-Ports.
2) The transmission comb (i.e., mapping to every 2^{nd}, 4^{th} or 8th subcarrier), configured by the RRC parameter transmissionComb, which includes:
   a) The comb offset, configured by the RRC parameter combOffset, is specified (i.e., which of the combs that should be used).
   b) The cyclic shift, configured by the RRC parameter cyclicShift, that configures a (port-specific, for multi-port SRS resources) cyclic shift for the Zadoff-Chu sequence that is used for SRS. The use of cyclic shifts increases the number of SRS resources that can be mapped to a comb (as SRS sequences are designed to be (almost) orthogonal under cyclic shifts), but there is a limit on how many cyclic shifts that can be used (8 for comb 2, 12 for comb 4 and 6 for comb 8).
3) The time-domain position within a given slot, configured with the RRC parameter resourceMapping, which includes:
   a) The time-domain start position, which is limited to be one of the last 6 symbols (in NR Rel-15) or in any of the 14 symbols in a slot (in NR Rel-16 and 17), configured by the RRC parameter startPosition.
   b) The number of symbols for the SRS resource (that can be set to 1, 2 or 4), configured by the RRC parameter nrofSymbols (extended to up to 14 OFDM symbols in Rel-17).
   c) The repetition factor (that can be set to 1, 2 or 4), configured by the RRC parameter repetitionFactor. When the repetition factor is larger than 1, the same frequency resources are used multiple times across symbols, used to improve the coverage as this allows more energy to be collected by the receiver. The repetition factor was extended to include the following values in Rel-17: 1,2,4,5,6,7,8,10,12,14.
4) The sounding bandwidth, frequency-domain position and shift, and frequency-hopping pattern of an SRS resource (i.e., which part of the transmission bandwidth that is occupied by the SRS resource) is set through the RRC parameters freqDomainPosition, freqDomainShift, and the freqHopping parameters c-SRS, b-SRS, and b-hop. The smallest possible sounding bandwidth is 4 RBs.
5) The RRC parameter resourceType determines whether the SRS resource is transmitted as periodic, aperiodic (single transmission triggered by DCI), or semi persistent (same as periodic except for the start and stop of the periodic transmission is controlled through MAC CE signaling instead of RRC signaling).
6) The RRC parameter sequenceId specifies how the SRS sequence is initialized.
7) The RRC parameter spatialRelationInfo configures the spatial relation for the SRS beam with respect to another RS (which could be another SRS, an SSB or a CSI-RS). If an SRS resource has a spatial relation to another SRS resource, then this SRS resource should be transmitted with the same beam (i.e., virtualization) as the indicated SRS resource.

An SRS resource set is configured with the following in RRC (see ASN code in 3GPP TS 38.331).

| | |
|---|---|
| SRS-ResourceSet ::= | SEQUENCE { |
| srs-ResourceSetId | SRS-ResourceSetId, |
| srs-ResourceIdList | SEQUENCE |

(SIZE(1..maxNrofSRS-ResourcesPerSet)) OF SRS-ResourceId
OPTIONAL, -- Cond Setup

| | |
|---|---|
| resourceType | CHOICE { |
| aperiodic | SEQUENCE { |
| aperiodicSRS-ResourceTrigger | INTEGER |

(1..maxNrofSRS-TriggerStates-1),

| | |
|---|---|
| csi-RS | NZP-CSI-RS- |
| ResourceId | OPTIONAL, -- Cond NonCodebook |
| slotOffset | INTEGER |
| (1..32) | OPTIONAL, -- Need S |

```
      ...,
      [[
```

| | |
|---|---|
| aperiodicSRS-ResourceTriggerList | SEQUENCE |

(SIZE(1..maxNrofSRS-TriggerStates-2))

OF

```
INTEGER (1..maxNrofSRS-TriggerStates-1) OPTIONAL -- Need M
      ]]
    },
```

| | |
|---|---|
| semi-persistent | SEQUENCE { |
| associatedCSI-RS | NZP-CSI-RS- |
| ResourceId | OPTIONAL, -- Cond NonCodebook |

```
      ...
    },
```

| | |
|---|---|
| periodic | SEQUENCE { |
| associatedCSI-RS | NZP-CSI-RS- |
| ResourceId | OPTIONAL, -- Cond NonCodebook |

```
      ...
    }
  },
```

| | |
|---|---|
| usage | ENUMERATED |

{beamManagement, codebook, nonCodebook, antennaSwitching},

| | |
|---|---|
| alpha | Alpha |

OPTIONAL, -- Need S

| | |
|---|---|
| p0 | INTEGER (−202..24) |

OPTIONAL, -- Cond Setup

| | |
|---|---|
| pathlossReferenceRS | PathlossReferenceRS- |
| Config | OPTIONAL, -- Need M |
| srs-PowerControlAdjustmentStates | ENUMERATED { |
| sameAsFci2, separateClosedLoop} | OPTIONAL, -- Need S |

```
  ...,
  [[
```

| | |
|---|---|
| pathlossReferenceRSList-r16 | SetupRelease { |
| PathlossReferenceRSList-r16} | OPTIONAL -- Need M |

]]
}

SRS resource(s) will be transmitted as part of an SRS resource set, where all SRS resources in the same SRS resource set must share the same resource type.

The resource usage, which is configured by the RRC parameter usage sets constraints and assumptions on the resource properties (see 3GPP TS 38.214 for further details). SRS resource sets can be configured with one of four different usages: ‘antennaSwitching’, ‘codebook’, ‘nonCodebook’ and ‘beamManagement’.

An SRS resource set that is configured with usage ‘antennaSwitching’ is used for reciprocity-based DL precoding (i.e., used to sound the channel in the UL so that the gNB can use reciprocity to set a suitable DL precoders). The UE is expected to transmit one SRS port per UE antenna port.

An SRS resource set that is configured with usage ‘codebook’ is used for CB-based UL transmission (i.e., used to sound the different UE antennas and help the gNB to determine/signal a suitable UL precoder, transmission rank, and MCS for PUSCH transmission). There are up to two SRS resources in an SRS resource set with usage ‘codebook’. How SRS ports are mapped to UE antenna ports is, however, up to UE implementation and not known to the gNB.

An SRS resource set that is configured with usage ‘nonCodebook’ is used for NCB-based UL transmission. Specifically, the UE transmits one SRS resource per candidate beam (suitable candidate beams are determined by the UE based on CSI-RS measurements in the DL and, hence, reciprocity needs to hold). The gNB can then, by indicating a subset of these SRS resources, determine which UL beam(s) that the UE should apply for PUSCH transmission. One UL layer will be transmitted per indicated SRS resource. Note that how the UE maps SRS ports to antenna ports is up to UE implementation and not known to the gNB.

An SRS resource set that is configured with usage ‘beamManagement’ is used (mainly for frequency bands above 6 GHz (i.e., for FR2)) to evaluate different UE beams for analog beamforming arrays. The UE transmits one SRS resource per analog beam, and the gNB will perform an RSRP measurement per transmitted SRS resource and, in this way, determine a suitable UE beam that is reported to the UE.

To summarize, the SRS resource-set configuration determines, e.g., usage, power control, and slot offset for aperiodic SRS. The SRS resource configuration determines the time-and-frequency allocation, the periodicity and offset, the sequence, and the spatial-relation information.

### SUMMARY

Systems and methods of a probing beam procedure are provided. In some embodiments, a method performed by a User Equipment (UE) for evaluating candidate beam pair links includes: indicating support for probing Uplink (UL) Reference Signal (RS) during capability signalling; determining a spatial filter for a UL-RS transmission based on one or more Downlink (DL) Reference Signals (DL-RSs); updating the spatial relation of an UL-RS; and transmitting UL-RS directly without a need of explicit spatial relation update for the UL-RS from a network node. In this way, some embodiments enable the network to evaluate candidate beam pair links based on an UL-RS transmission of a UE, without the need to explicitly indicate spatial filter that the UE shall use for the UL-RS transmission. In addition, some embodiments describe several solutions on how to perform the methods with reduced UL-RS overhead by letting the UE help when to trigger the UL-RS transmission.

In some embodiments, a method performed by a network node for evaluating candidate beam pair links includes: receiving, from a UE, an indication regarding support for probing UL-RS during capability signalling; determining the spatial filter for the UL-RS transmission based on a group of DL-RSs; receiving an UL-RS directly without a need of explicit spatial relation update for the UL-RS from the network node; and updating the spatial relation of an UL-RS.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates two types of beams for beam management procedures, one is referred to as a “connected beam”, and the other is referred to as a “probing beam”, according to some embodiments of the present disclosure;

FIG. 2 depicts the flowchart for the probing UL-RS procedure, according to some embodiments of the present disclosure;

FIG. 3 shows an example of a communication system in accordance with some embodiments of the present disclosure;

FIG. 4 shows a User Equipment device (UE) in accordance with some embodiments of the present disclosure;

FIG. 5 shows a network node in accordance with some embodiments of the present disclosure;

FIG. 6 is a block diagram of a host, which may be an embodiment of the host of FIG. 3, in accordance with various aspects of the present disclosure described herein;

FIG. 7 is a block diagram illustrating a virtualization environment in which functions implemented by some embodiments of the present disclosure may be virtualized; and

FIG. 8 shows a communication diagram of a host communicating via a network node with a UE over a partially wireless connection in accordance with some embodiments of the present disclosure.

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Some of the embodiments contemplated herein will now be described more fully with reference to the accompanying drawings. Embodiments are provided by way of example to convey the scope of the subject matter to those skilled in the art.

There currently exist certain challenge(s). For wireless deployment for large antenna array or for high frequency band, multiple beams are used in the communication system to achieve good coverage and performance.

Problem with the legacy procedure is the large latency from the time UE detected the best beam until the time UE gets indication from the gNB to switch to the best beam. It has been observed that the best beam may change very frequently that the beam management procedure involving MAC CE and/or DCI signalling based beam refinement and beam indication steps cause signalling overhead and large latency.

Besides the heavy signalling involved with the existing procedures, the existing UE in the market has limited capability in number of periodic or aperiodic SRS resources, number of activated TCI states etc., which makes the legacy beam management procedure more cumbersome to implement.

In a previous disclosure, several different solutions on how to dynamically update the spatial source (or spatial relation) of an SRS transmission used for probing candidate beam pair links are presented, and where the updated spatial source is indicated from gNB to the UE with reference to a previously signaled SSB beam report. The indicated spatial source of the SRS transmission is used by the UE to determine a suitable spatial filter for the SRS transmission. However, those solutions involve beam reports from the UE to the gNB, which are used by the gNB to determine a spatial source for SRS transmission and indicating the determined spatial source for the SRS transmission to the UE. Relying on beam reports requires frequent signaling and higher signaling overhead, which will reduce the overall UL capacity in the network.

Therefore, how to determine spatial source of UL-RS without high signaling overhead in UL (due to beam reporting involving beam measurements made on SSB/CSI-RS) and in DL (due to explicit signaling to update the spatial source of UL-RS from gNB to the UE) is an open problem to be solved.

Certain aspects of the disclosure and their embodiments may provide solutions to these or other challenges. This disclosure describes several different methods on how to evaluate candidate beam pair links between a UE and a gNB based on UL-RS (e.g., SRS in NR or a new UL-RS in 6G) transmission from the UE, where an indication of which spatial filter the UE can use for the UL-RS is indicated to the gNB without the need for previously reported beam report(s).

Upon gNB request, the UE updates the spatial relation of an uplink reference signal, and transmits UL-RS directly without a need of explicit spatial relation update for the UL-RS from the gNB. In some embodiments, this is without a need of an explicit signaling from the gNB to update spatial relation for the UL-RS.

Certain embodiments may provide one or more of the following technical advantage(s). The solution enables the network to evaluate candidate beam pair links based on an UL-RS transmission of a UE, without the need to explicitly indicate spatial filter that the UE shall use for the UL-RS transmission.

In addition, the some embodiments of the current disclosure describe several solutions on how to perform the methods with reduced UL-RS overhead by letting the UE help when to trigger the UL-RS transmission.

Transmission priority of probing UL-RS is briefly introduced to resolve transmission collision cases.

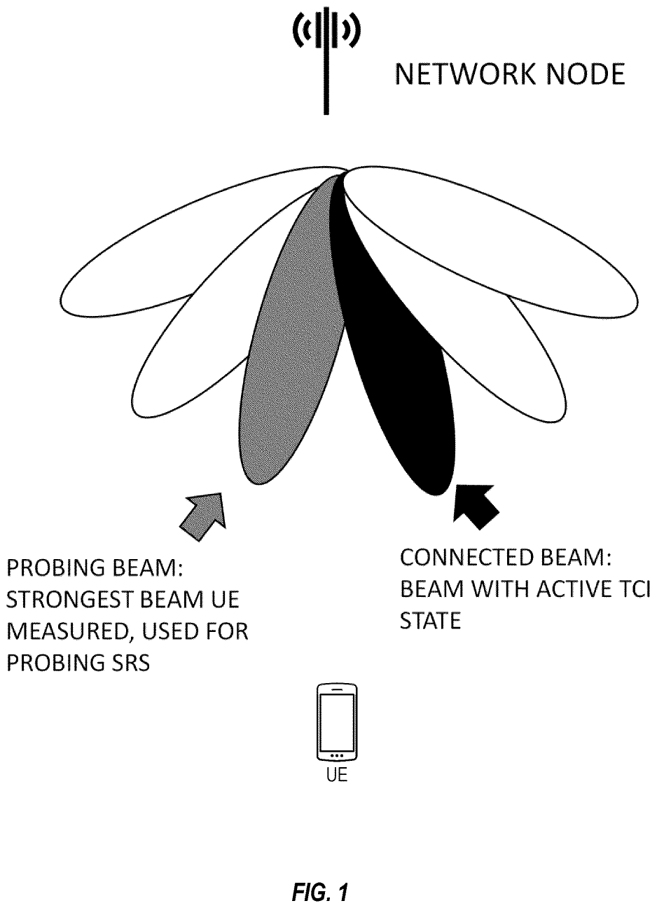

In the solutions described in the disclosure, two types of beams are envisioned for beam management procedures, one is referred to as a “connected beam”, and the other is referred to as a “probing beam”, see FIG. 1. Connected beam (or beam pair link) is the beam (or beam pair link) known and acknowledged between the network and UE to be used for communication. One example of a connected beam can be a joint DL/UL TCI state, from the unified TCI state framework, indicated to the UE, or similar mechanisms for 6G.

In the legacy framework, UE receives information about the beams that the network node will use already in the initial access stage when UE for the first time connects to the network. After entering the RRC-connected phase, a UE will further receive information about the one or multiple downlink beams used by the network node from diverse network configurations. The UE monitors and measures the configured downlink reference signals associated with different DL beams according to the configured time- and frequency-resources. Based on measurement result(s), the “best” DL beams(s) among the multiple beams will be determined. For NR the downlink beams can be associated with DL-RS e.g., SSB, or CSI-RS, etc.

The probing beam is a beam pair link that the UE would like the gNB to evaluate as it could achieve better performance compared to the “connected beam”. In some embodiments of the current disclosure, the probing beam is evaluated by the gNB by letting the UE transmit UL-RS and the network can use reciprocity to determine a suitable UE beam, and, possibly, gNB beam.

### Probing Beam in the Uplink

As described previously, the probing beam is used for evaluating candidate beam pair links between the UE and the network based on UL-RS transmitted from the UE. In principle, the UL-RS transmission can be triggered either by the network, or by the UE. After UE has transmitted the UL-RS, the network can evaluate candidate beam pair links between the gNB and the UE, and indicate the preferred beam/beam pair link to the UE, e.g., using some form of TCI/QCL indication or indication of the spatial relation.

Next, one method of management of probing beams in the uplink based on a new type of “probing SRS” is described. Capabilities related to the “probing SRS” is described in herein, whilst the configuration aspects of the “probing SRS” are addressed in herein. In NR/6G the “probing SRS” might be called something else and might be another UL-RS than an SRS.

### UE Capabilities on Probing UL-RS

In a preferred embodiment, the UL-RS is an SRS.

In one embodiment, the UE indicates support for “probing UL-RS” during UE capability signalling. In one embodiment the indication of the support for “probing UL-RS” during UE capability signalling, indicates one or more of the following information:
Periodic, aperiodic and/or semi-persistent transmission of the (probing) UL-RS
Support of UE initiated transmission of the UL-RS
   SSB based monitoring for trigger condition for UL-RS transmission
   CSI-RS based monitoring for trigger condition for UL-RS transmission
   “Other DL-RS in for 6G”-based monitoring for trigger condition for UL-RS transmission
DL-RS based monitoring of spatial filter determination of UL-RS transmission
   SSB based monitoring for determining spatial filter for UL-RS transmission
   CSI-RS based monitoring for determining spatial filter for UL-RS transmission
   “Other DL-RS in for 6G” based monitoring for determining spatial filter for UL-RS transmission
UL-RS transmission from multiple UE panels (“panel sweeping”, i.e., where the UE is mandated to transmit UL-RS from more than one UE panel, to evaluate candidate beam pair links in multiple different directions seen from the UE)
   Number of panels to sweep through
   Support of simultaneously transmitting from maximum X number of panels
UL-RS transmission in different UE beams (“beam sweeping”, i.e., where the UE is mandated to transmit UL-RS from more than one UE beam, to evaluate candidate beam pair links in multiple different directions seen from the UE)
   Preferred number of UE beams to sweep through (can for example be based on how many narrow beams the UE has per UE panel)
UL-RS transmission from autonomously selected UE panel
   Based on power headroom, SAR (specific absorption rate), antenna distribution that is known better at the UE side

### High-Level Embodiments of Probing UL-RS

### Network Node Triggered UL-RS Transmission

In one embodiment, the probing UL-RS transmission is triggered by the network node. Upon receiving the probing UL-RS transmission triggering, the UE shall determine the spatial filter for the UL-RS transmission based on a group of DL reference signals (SSBs, CSI-RS or new DL-RS for 6G). In one related embodiment, the DL-RSs are based on two or more DL-RSs. In one detailed embodiment, which DL-RSs (e.g., a group of SSBs) the UE shall use to determine the relevant spatial filter is configured by the network. In another embodiment, all the cell-defining SSBs indicated to the UE during initial access, are used by default (unless other dedicated configuration has been signaled).

In one embodiment, the UE transmits the probing UL-RS with a spatial filter associated with a DL-RS that is received with strongest RSRP out of the configured groups of DL-RSs.

In one embodiment, the UE transmits the probing UL-RS with a spatial filter associated with one DL-RS that is one of the DL-RSs received with strongest RSRP out of the configured groups of DL-RSs. UE autonomously decides which one DL-RS to be used to determine the spatial filter to be used to transmit the probing UL-RS. In another embodiment, if the UE is equipped with multiple panels, which panel to transmit the probing UL-RS from is determined by the UE.

In one embodiment, the UE is configured to transmit probing UL-RSs from multiple different panels, for example one probing UL-RS per UE panel to let the network evaluate candidate beam pair links in all different directions of the UE. In one embodiment, to determine beams (or spatial filters) for simultaneous transmission/reception from N (N>1) UE panels, the UE determines to N>1 spatial filters from N>1 SSBs or CSI-RSs that can be simultaneously received. The N>1 spatial filters used may be determined using any one of the following criterions:
N>1 SSBs/CSI-RSs that have the highest L1-RSRPs
N>1 SSBs/CSI-RSs determined such that each determined SSB/CSI-RS when measured from each of the N>1 UE panels result in the highest L1-RSRP for that UE panel
N>1 SSBs/CSI-RSs that have the highest L1-SINRs such that inter-beam interference between the determined SSBs/CSI-RSs is minimized
N>1 SSBs/CSI-RSs determined such that each determined SSB/CSI-RS when measured from each of the N>1 UE panels result in the highest L1-SINR for that UE panel

### UE Triggered UL-RS Transmission

In one alternative embodiment, the probing UL-RS transmission can be event-triggered by the UE, such that if the UE is configured with a “connected beam” used for DL and/or UL communication (e.g. the UE is indicate with a joint DL/UL TCI state for the unified TCI state framework or similar for 6G), and the UE determines that another SSB/CSI-RS beam has a better link budget (e.g., has larger L1-RSRP including potential threshold, such that “L1-RSRP new beam”>“L1-RSRP current beam”+“Threshold”; or a larger L1-SINR including potential threshold, such that “L1-SINR new beam”>“L1-SINR current beam”+“Threshold”), then the UE triggers the probing UL-RS transmission. In one optional embodiment, in order to inform the gNB about the UE triggered probing UL-RS transmission, the UE may first transmit some kind of scheduling request or PRACH or similar UL signal to indicate to the network that the probing UL-RS transmission will be transmitted by the UE. In another embodiment, the UE is configured with periodic or semi-persistent probing UL-RS resource, but where the UE only perform the actual probing UL-RS transmission when the event has been triggered (which will save UL-RS transmission power at the UE and reduce UL-RS interference in the system). For instance, in a periodic or semi-persistent probing UL-RS resource (which happens with a given probing UL-RS periodicity), the UE will transmit a probing UL-RS in a given periodic/semi-persistent probing UL-RS resource period if the probing UL-RS event was triggered in that period. If a probing UL-RS event was not triggered in that period, the UE will not transmit a probing UL-RS in that given periodic/semi-persistent probing UL-RS resource periodic.

### Configuration of Probing UL-RS

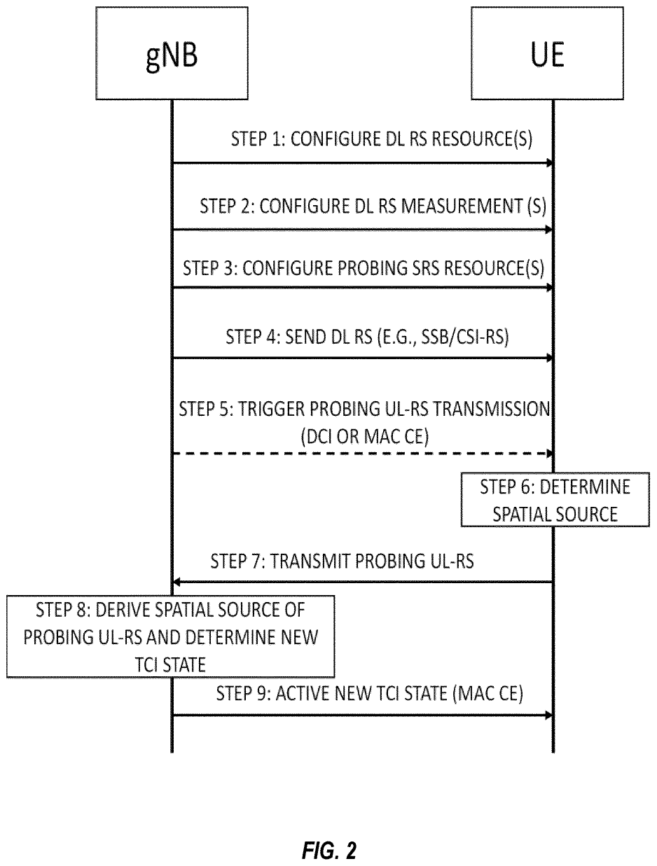

FIG. 2 depicts a method for the probing UL-RS procedure, according to some embodiments of the current disclosure. Here, SRS is used for the probing UL-RS. However, the current disclosure is not limited thereto.

In a Step 1, the network node configures one or multiple DL-RS resource(s) (e.g., SSB, CSI-RS, etc.) to the UE, via higher layer signaling, e.g., RRC etc.

In a Step 2, the network node configures one or multiple measurement configuration(s) for the said DL-RS resource(s) to UE, via higher layer signaling, e.g., RRC, etc.

In a Step 3, the network provides the higher layer configuration of the probing UL-RS resource(s) to UE, via higher layer signaling, e.g., RRC etc. The resource configuration of the probing UL-RS will inherit most of the legacy SRS resource configuration options, e.g., time-and-frequency allocation, the periodicity and offset, the sequence etc. Below gives some examples of configuration which is typical to the probing UL-RS.

In one embodiment, the probing UL-RS resource set can be configured with a resource type of aperiodic, semi-persistent, or periodic.

In one embodiment, the probing UL-RS resource set can be configured with a new usage type, e.g., probing. Alternatively, the UL-RS resource set can be configured with an existing type, e.g., BeamManagement (BM) with a flag set configured to enable probing. In another embodiment, one or more of the UL-RS resources in an UL-RS resource set (that in some embodiments may be configured with an existing UL-RS usage, e.g., BM usage) may be configured with respective flags to enable probing UL-RS.

In one embodiment, the probing UL-RS resource is not configured with a spatial relation info (e.g., the probing UL-RS doesn't have the legacy SRS-SpatialRelationInfo configured) or a joint/UL TCI state which is different from the existing options. In particular, the probing UL-RS will not have a higher layer configured (fixed) spatial relation information. Instead, the spatial source of a probing UL-RS resource is dynamically determined by the UE based on a gNB configured determination method or a predetermined determination method. Alternatively, a probing UL-RS may be configured with a new type of SRS-SpatialRelationInfo, different from the existing SRS-SpatialRelationInfo. Instead, the probing UL-RS is configured with a new higher layer parameter to instruct the UE how to determine the spatial source.

In one embodiment, the gNB can provide to the UE that the determination of the spatial source is based on Layer 1 measurement where one measurement object may include one or more of
Measurement method, e.g., based on L1-RSRP or based on L1-SINR
Measurement duration or time resource, e.g., the maximum/minimum measurement period in which the measurement result is obtained
Measurement objective, e.g., SSB which has the best L1-RSRP, SSB which has the best L1-SINR
. . .

In one embodiment, the measurement criteria comprise one or more of measurement quantity, measurement duration, average of multiple DL-RSs over time, etc.

In one embodiment, the network node can configure that the determination of the spatial source can use one or multiple measurement results from e.g., handover (HO) procedure, Beam Failure Detection (BFD), Beam Failure Recovery (BFR), etc.

In an alternative embodiment, the spatial source determination method can be pre-specified by 3GPP specification, without explicit signaling from the network node. One example is that the spatial source of the probing UL-RS is the DL-RS that is received with strongest L1-RSRP out of the configured groups of DL-RSs.

In one embodiment, the network node can configure UE with a set of determination methods, via higher-layer parameters (e.g., RRC), to determine the spatial source of the probing UL-RS. In an optional embodiment, the selection of the method can be indicated via MAC CE or DCI signalling.

In one embodiment, UE is configured to transmit the probing UL-RS based on the strongest/best beam that the UE measured at a time tm before the transmission occasion t, where tm is related to the reception time of the DL-RS (e.g., SSB). For example, the time delay between the “latest measurement” and the probing UL-RS transmission is dependent on the amount of time UE needs to process the measurement based on transmitted beam on the downlink, as well as the amount of time UE needs to prepare for uplink transmission associated with selected beam and the probing beam configuration. The time delay also depends on if the probing UL-RS transmission is a periodic transmission, a semi-persistent transmission activated by MAC CE, or an aperiodic transmission triggered by DCI. To mirror the current beam sweeping of SRS for the UL beam management, the aperiodic UL-RS transmission can be consecutive UL-RS resources with multiple UL probing beams as the corresponding spatial sources, for example,
Probing UL-RS resource 1: the spatial source is the best measured SSB beam
Probing UL-RS resource 2: the spatial source is the second best measured SSB beam
Probing UL-RS resource 3: the spatial source is the third best measured SSB beam
. . .

In one embodiment, the number of antenna ports for the probing UL-RS configuration is 1 by default.

In a Step 4, the network node sends the DL-RS(s) according to the configured DL-RS resource(s).

In a Step 5 which is only applicable to embodiments where the network triggers the probing UL-RS, the network node triggers the UE to transmit the AP probing UL-RS resource(s) via e.g., DCI using a field(s) in DCI 0_1/0_2/1_1/1_2, and if needed the UE should update the spatial source used for the AP probing UL-RS resource(s), according to the configured determination method. Alternatively, the network node can trigger the UE to transmit the SP probing UL-RS resource (s) via e.g., MAC CE, and if needed the UE should update the spatial source used for the SP probing UL-RS resource(s), according to determination method. In other word, the decision on which physical panel and floating/probing beam to use for the probing UL-RS transmission is decided at UE side based on the spatial relation determination method provided to the UE.

Some examples of the triggering conditions for gNB to send the above DCI or MAC CE signaling can be:
The network node observed degradation of the connected beam/link from channel state indication feedback, e.g., down step of MCS, or rank indication etc
The network node observed increased BLER and/or packet loss, and/or HARQ retransmission e.g., of the wireless communication to the UE
The network received beam failure request from UE
The network observed reduced data throughput to the UE
The network measured the reference signal of connected beam received from the UE, the reference signal can be DMRS from PUSCH or SRS, and observed rapid change in the channel estimation parameters such as SINR or autocorrelation between the two UL RS within certain period.

In one embodiment, the same DCI or MAC CE can trigger the transmission of the probing UL-RS, for one, or a set of, or all probing UL-RS resource(s). Upon receiving the UL-RS trigger from the network node, the UE will need to determine the spatial relation for the probing UL-RS.

In one embodiment, the same DCI or MAC CE may also be used to indicate an update of the determination method for the determination of the spatial source of the probing UL-RS among the set of configured determination methods.

In an alternative embodiment, instead of network triggers probing UL-RS described in Step 5, the transmission of the probing UL-RS can be triggered by the UE, without an explicit triggering signaling from the network node. In one example, if the UE is configured with a “connected beam” used for DL and/or UL communication (e.g., the UE is indicate with a joint DL/UL TCI state for the unified TCI state framework or similar for 6G), and the UE notices that another SSB beam has a better link budget (e.g. has larger RSRP including potential threshold, such that: “RSRP new beam”>“RSRP current beam”+“Threshold”), then the UE triggers the UL-RS transmission. In a related embodiment, to inform the gNB about the triggered UL-RS transmission, the UE first transmits some kind of scheduling request or PRACH or similar UL signal to indicate to the network that the UL-RS transmission will happen. In another embodiment, the UE is configured with periodic or semi-persistent UL-RS resource, but where the UE only perform the actual UL-RS transmission when the event has been triggered (which will save UL-RS transmission power at the UE and reduce UL-RS interference in the system).

In a Step 6, the UE determines the source RS for determining the spatial filter for the probing UL-RS.

In one related embodiment, the UE may determine the source RS upon receiving the triggering DCI or MAC CE for UL-RS transmission from the network node. Alternatively, the UE may determine the source RS without an UL-RS transmission signaling from the network node.

In one alternative embodiment, the UE may be instructed to update the determination method of the spatial source for the probing UL-RS according to the indication carried in DCI or MAC CE, as described in the Step 5.

In a Step 7, the UE updates the source RS for determining the spatial filter of the probing UL-RS based on the said determination from the Step 6 and transmit the probing UL-RS to the gNB.

In a Step 8, the gNB may derive the source RS for the spatial relation of the probing UL-RS based on the UL-RS measurement, and accordingly determines the need to activate a new TCI state, via e.g., MAC CE signaling.

In one embodiment, the gNB may determine the need to activate a new TCI state based on multiple probing UL-RS measurements.

In a Step 9, the gNB activates a new TCI state to switch the connected beam based on the determination of the Step 8.

### Transmission Collision

Transmission/reception conflict may occur due to the dynamically updated spatial relation of the probing beam. In this case, the conflict can be solved by one or a set of predefined rules. In the following descriptions, transmission with higher priority is prioritized to transmit over transmission/reception with lower priority. In one embodiment, periodic or semi-persistent probing UL-RS has lower priority than dynamic transmission for PUSCH or PDSCH. In one embodiment, periodic or semi-persistent probing UL-RS has lower priority than periodic or semi-persistent transmission using connected beam for PUSCH and/or SRS and/or PDSCH, e.g., Type1 or Type2 Configured Grant PUSCH or semi-persistent CSI on PUSCH or DL SPS.

In one embodiment, periodic or semi-persistent probing UL-RS has higher priority than periodic or semi-persistent transmission using connected beam for PUSCH and/or SRS and/or PDSCH, e.g., Type1 or Type2 Configured Grant PUSCH or semi-persistent CSI on PUSCH or DL SPS. In one embodiment, aperiodic probing UL-RS has higher priority than semi-persistent or periodic transmission using connected beam, e.g., configured grant PUSCH, SRS. In one embodiment, periodic or semi-persistent probing UL-RS has lower priority than UL transmission on PUSCH and/or SRS using connected beam. In one embodiment, aperiodic probing UL-RS has higher priority than uplink transmission via PUSCH or SRS using connected beam. In one embodiment, the priority of periodic and/or semi-persistent and/or aperiodic probing UL-RS can be configured via higher layer signaling.

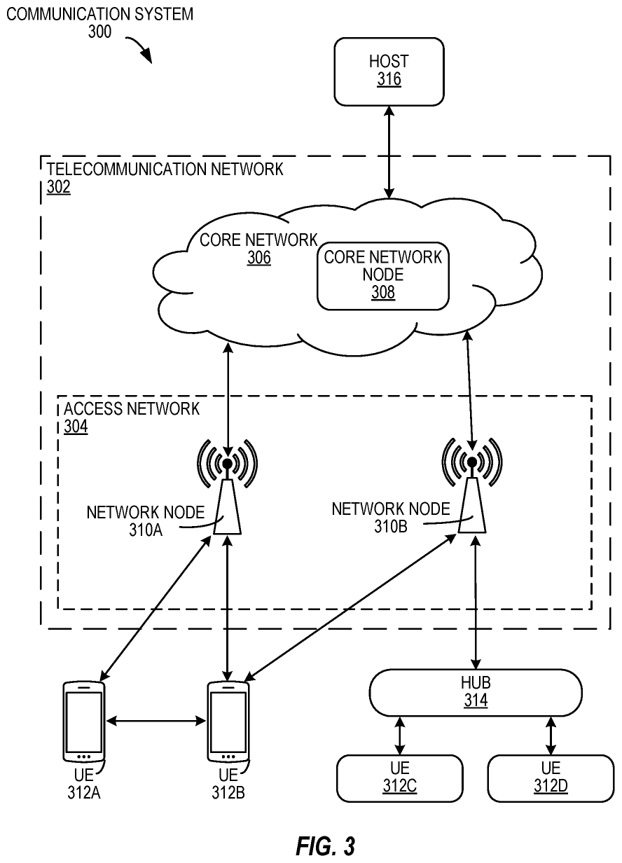

FIG. 3 shows an example of a communication system 300 in accordance with some embodiments. In the example, the communication system 300 includes a telecommunication network 302 that includes an access network 304, such as a Radio Access Network (RAN), and a core network 306, which includes one or more core network nodes 308. The access network 304 includes one or more access network nodes, such as network nodes 310A and 310B (one or more of which may be generally referred to as network nodes 310), or any other similar Third Generation Partnership Project (3GPP) access nodes or non-3GPP Access Points (APs). Moreover, as will be appreciated by those of skill in the art, a network node is not necessarily limited to an implementation in which a radio portion and a baseband portion are supplied and integrated by a single vendor. Thus, it will be understood that network nodes include disaggregated implementations or portions thereof. For example, in some embodiments, the telecommunication network 302 includes one or more Open-RAN (ORAN) network nodes. An ORAN network node is a node in the telecommunication network 302 that supports an ORAN specification (e.g., a specification published by the O-RAN Alliance, or any similar organization) and may operate alone or together with other nodes to implement one or more functionalities of any node in the telecommunication network 302, including one or more network nodes 310 and/or core network nodes 308.

Examples of an ORAN network node include an Open Radio Unit (O-RU), an Open Distributed Unit (O-DU), an Open Central Unit (O-CU), including an O-CU Control Plane (O-CU-CP) or an O-CU User Plane (O-CU-UP), a RAN intelligent controller (near-real time or non-real time) hosting software or software plug-ins, such as a near-real time control application (e.g., xApp) or a non-real time control application (e.g., rApp), or any combination thereof (the adjective “open” designating support of an ORAN specification). The network node may support a specification by, for example, supporting an interface defined by the ORAN specification, such as an A1, F1, W1, E1, E2, X2, Xn interface, an open fronthaul user plane interface, or an open fronthaul management plane interface. Moreover, an ORAN access node may be a logical node in a physical node. Furthermore, an ORAN network node may be implemented in a virtualization environment (described further below) in which one or more network functions are virtualized. For example, the virtualization environment may include an O-Cloud computing platform orchestrated by a Service Management and Orchestration Framework via an 0-2 interface defined by the O-RAN Alliance or comparable technologies. The network nodes 310 facilitate direct or indirect connection of User Equipment (UE), such as by connecting UEs 312A, 312B, 312C, and 312D (one or more of which may be generally referred to as UEs 312) to the core network 306 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 300 may include any number of wired or wireless networks, network nodes, UEs, and/or any other components or systems that may facilitate or participate in the communication of data and/or signals whether via wired or wireless connections. The communication system 300 may include and/or interface with any type of communication, telecommunication, data, cellular, radio network, and/or other similar type of system.

The UEs 312 may be any of a wide variety of communication devices, including wireless devices arranged, configured, and/or operable to communicate wirelessly with the network nodes 310 and other communication devices. Similarly, the network nodes 310 are arranged, capable, configured, and/or operable to communicate directly or indirectly with the UEs 312 and/or with other network nodes or equipment in the telecommunication network 302 to enable and/or provide network access, such as wireless network access, and/or to perform other functions, such as administration in the telecommunication network 302.

In the depicted example, the core network 306 connects the network nodes 310 to one or more hosts, such as host 316. These connections may be direct or indirect via one or more intermediary networks or devices. In other examples, network nodes may be directly coupled to hosts. The core network 306 includes one more core network nodes (e.g., core network node 308) that are structured with hardware and software components. Features of these components may be substantially similar to those described with respect to the UEs, network nodes, and/or hosts, such that the descriptions thereof are generally applicable to the corresponding components of the core network node 308. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-Concealing Function (SIDF), Unified Data Management (UDM), Security Edge Protection Proxy (SEPP), Network Exposure Function (NEF), and/or a User Plane Function (UPF).

The host 316 may be under the ownership or control of a service provider other than an operator or provider of the access network 304 and/or the telecommunication network 302, and may be operated by the service provider or on behalf of the service provider. The host 316 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 300 of FIG. 3 enables connectivity between the UEs, network nodes, and hosts. In that sense, the communication system 300 may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable Second, Third, Fourth, or Fifth Generation (2G, 3G, 4G, or 5G) standards, or any applicable future generation standard (e.g., Sixth Generation (6G)); Wireless Local Area Network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any Low Power Wide AreaNetwork (LPWAN) standards such as LoRa and Sigfox.

In some examples, the telecommunication network 302 is a cellular network that implements 3GPP standardized features. Accordingly, the telecommunication network 302 may support network slicing to provide different logical networks to different devices that are connected to the telecommunication network 302. For example, the telecommunication network 302 may provide Ultra Reliable Low Latency Communication (URLLC) services to some UEs, while providing enhanced Mobile Broadband (eMBB) services to other UEs, and/or massive Machine Type Communication (mMTC)/massive Internet of Things (IoT) services to yet further UEs.

In some examples, the UEs 312 are configured to transmit and/or receive information without direct human interaction. For instance, a UE may be designed to transmit information to the access network 304 on a predetermined schedule, when triggered by an internal or external event, or in response to requests from the access network 304. Additionally, a UE may be configured for operating in single- or multi-Radio Access Technology (RAT) or multi-standard mode. For example, a UE may operate with any one or combination of WiFi, New Radio (NR), and LTE, i.e., being configured for Multi-Radio Dual Connectivity (MR-DC), such as Evolved UMTS Terrestrial RAN (E-UTRAN) NR-Dual Connectivity (EN-DC).

In the example, a hub 314 communicates with the access network 304 to facilitate indirect communication between one or more UEs (e.g., UE 312C and/or 312D) and network nodes (e.g., network node 310B). In some examples, the hub 314 may be a controller, router, content source and analytics, or any of the other communication devices described herein regarding UEs. For example, the hub 314 may be a broadband router enabling access to the core network 306 for the UEs. As another example, the hub 314 may be a controller that sends commands or instructions to one or more actuators in the UEs. Commands or instructions may be received from the UEs, network nodes 310, or by executable code, script, process, or other instructions in the hub 314. As another example, the hub 314 may be a data collector that acts as temporary storage for UE data and, in some embodiments, may perform analysis or other processing of the data. As another example, the hub 314 may be a content source. For example, for a UE that is a Virtual Reality (VR) headset, display, loudspeaker or other media delivery device, the hub 314 may retrieve VR assets, video, audio, or other media or data related to sensory information via a network node, which the hub 314 then provides to the UE either directly, after performing local processing, and/or after adding additional local content. In still another example, the hub 314 acts as a proxy server or orchestrator for the UEs, in particular if one or more of the UEs are low energy IoT devices.

The hub 314 may have a constant/persistent or intermittent connection to the network node 310B. The hub 314 may also allow for a different communication scheme and/or schedule between the hub 314 and UEs (e.g., UE 312C and/or 312D), and between the hub 314 and the core network 306. In other examples, the hub 314 is connected to the core network 306 and/or one or more UEs via a wired connection. Moreover, the hub 314 may be configured to connect to a Machine-to-Machine (M2M) service provider over the access network 304 and/or to another UE over a direct connection. In some scenarios, UEs may establish a wireless connection with the network nodes 310 while still connected via the hub 314 via a wired or wireless connection. In some embodiments, the hub 314 may be a dedicated hub—that is, a hub whose primary function is to route communications to/from the UEs from/to the network node 310B. In other embodiments, the hub 314 may be a non-dedicated hub—that is, a device which is capable of operating to route communications between the UEs and the network node 310B, but which is additionally capable of operating as a communication start and/or end point for certain data channels.

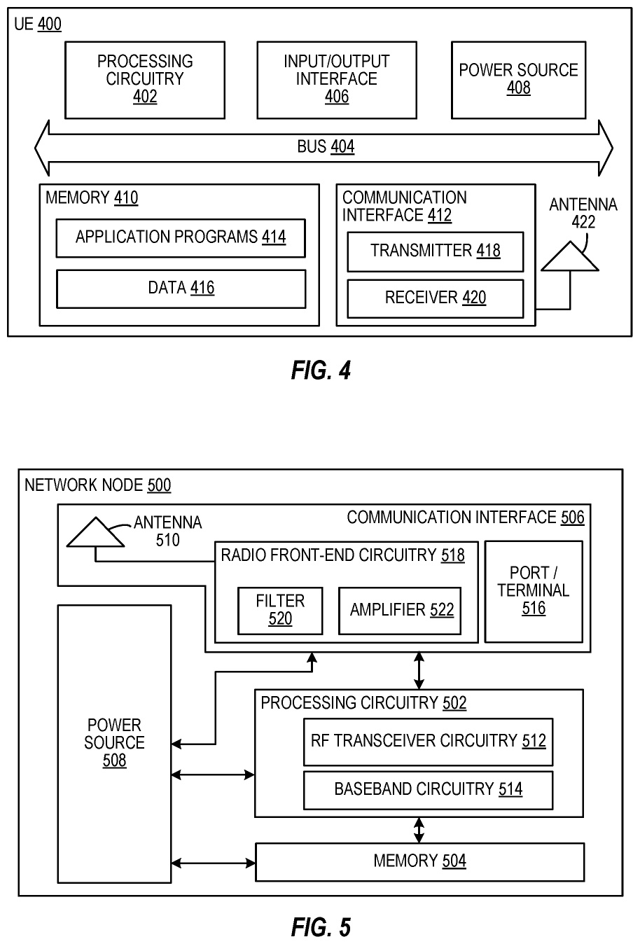

FIG. 4 shows a UE 400 in accordance with some embodiments. As used herein, a UE refers to a device capable, configured, arranged, and/or operable to communicate wirelessly with network nodes and/or other UEs. Examples of a UE include, but are not limited to, a smart phone, mobile phone, cell phone, Voice over Internet Protocol (VoIP) phone, wireless local loop phone, desktop computer, Personal Digital Assistant (PDA), wireless camera, gaming console or device, music storage device, playback appliance, wearable terminal device, wireless endpoint, mobile station, tablet, laptop, Laptop Embedded Equipment (LEE), Laptop Mounted Equipment (LME), smart device, wireless Customer Premise Equipment (CPE), vehicle, vehicle-mounted or vehicle embedded/integrated wireless device, etc. Other examples include any UE identified by the 3GPP, including a Narrowband Internet of Things (NB-IoT) UE, a Machine Type Communication (MTC) UE, and/or an enhanced MTC (eMTC) UE.

A UE may support Device-to-Device (D2D) communication, for example by implementing a 3GPP standard for sidelink communication, Dedicated Short-Range Communication (DSRC), Vehicle-to-Vehicle (V2V), Vehicle-to-Infrastructure (V2I), or Vehicle-to-Everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 400 includes processing circuitry 402 that is operatively coupled via a bus 404 to an input/output interface 406, a power source 408, memory 410, a communication interface 412, and/or any other component, or any combination thereof. Certain UEs may utilize all or a subset of the components shown in FIG. 4. The level of integration between the components may vary from one UE to another UE. Further, certain UEs may contain multiple instances of a component, such as multiple processors, memories, transceivers, transmitters, receivers, etc.

The processing circuitry 402 is configured to process instructions and data and may be configured to implement any sequential state machine operative to execute instructions stored as machine-readable computer programs in the memory 410. The processing circuitry 402 may be implemented as one or more hardware-implemented state machines (e.g., in discrete logic, Field Programmable Gate Arrays (FPGAs), Application Specific Integrated Circuits (ASICs), etc.); programmable logic together with appropriate firmware; one or more stored computer programs, general purpose processors, such as a microprocessor or Digital Signal Processor (DSP), together with appropriate software; or any combination of the above. For example, the processing circuitry 402 may include multiple Central Processing Units (CPUs).

In the example, the input/output interface 406 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 400. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 408 is structured as a battery or battery pack. Other types of power sources, such as an external power source (e.g., an electricity outlet), photovoltaic device, or power cell, may be used. The power source 408 may further include power circuitry for delivering power from the power source 408 itself, and/or an external power source, to the various parts of the UE 400 via input circuitry or an interface such as an electrical power cable. Delivering power may be, for example, for charging of the power source 408. Power circuitry may perform any formatting, converting, or other modification to the power from the power source 408 to make the power suitable for the respective components of the UE 400 to which power is supplied.

The memory 410 may be or be configured to include memory such as Random Access Memory (RAM), Read Only Memory (ROM), Programmable ROM (PROM), Erasable PROM (EPROM), Electrically EPROM (EEPROM), magnetic disks, optical disks, hard disks, removable cartridges, flash drives, and so forth. In one example, the memory 410 includes one or more application programs 414, such as an operating system, web browser application, a widget, gadget engine, or other application, and corresponding data 416. The memory 410 may store, for use by the UE 400, any of a variety of various operating systems or combinations of operating systems.

The memory 410 may be configured to include a number of physical drive units, such as Redundant Array of Independent Disks (RAID), flash memory, USB flash drive, external hard disk drive, thumb drive, pen drive, key drive, High Density Digital Versatile Disc (HD-DVD) optical disc drive, internal hard disk drive, Blu-Ray optical disc drive, Holographic Digital Data Storage (HDDS) optical disc drive, external mini Dual In-line Memory Module (DIMM), Synchronous Dynamic RAM (SDRAM), external micro-DIMM SDRAM, smartcard memory such as a tamper resistant module in the form of a Universal Integrated Circuit Card (UICC) including one or more Subscriber Identity Modules (SIMs), such as a Universal SIM (USIM) and/or Internet Protocol Multimedia Services Identity Module (ISIM), other memory, or any combination thereof. The UICC may for example be an embedded UICC (eUICC), integrated UICC (iUICC) or a removable UICC commonly known as a ‘SIM card.’ The memory 410 may allow the UE 400 to access instructions, application programs, and the like stored on transitory or non-transitory memory media, to off-load data, or to upload data. An article of manufacture, such as one utilizing a communication system, may be tangibly embodied as or in the memory 410, which may be or comprise a device-readable storage medium.

The processing circuitry 402 may be configured to communicate with an access network or other network using the communication interface 412. The communication interface 412 may comprise one or more communication subsystems and may include or be communicatively coupled to an antenna 422. The communication interface 412 may include one or more transceivers used to communicate, such as by communicating with one or more remote transceivers of another device capable of wireless communication (e.g., another UE or a network node in an access network). Each transceiver may include a transmitter 418 and/or a receiver 420 appropriate to provide network communications (e.g., optical, electrical, frequency allocations, and so forth). Moreover, the transmitter 418 and receiver 420 may be coupled to one or more antennas (e.g., the antenna 422) and may share circuit components, software, or firmware, or alternatively be implemented separately.

In the illustrated embodiment, communication functions of the communication interface 412 may include cellular communication, WiFi communication, LPWAN communication, data communication, voice communication, multimedia communication, short-range communications such as Bluetooth, NFC, location-based communication such as the use of the Global Positioning System (GPS) to determine a location, another like communication function, or any combination thereof. Communications may be implemented according to one or more communication protocols and/or standards, such as IEEE 802.11, Code Division Multiplexing Access (CDMA), Wideband CDMA (WCDMA), GSM, LTE, NR, UMTS, WiMax, Ethernet, Transmission Control Protocol/Internet Protocol (TCP/IP), Synchronous Optical Networking (SONET), Asynchronous Transfer Mode (ATM), Quick User Datagram Protocol Internet Connection (QUIC), Hypertext Transfer Protocol (HTTP), and so forth.

Regardless of the type of sensor, a UE may provide an output of data captured by its sensors, through its communication interface 412, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an IoT device, may be a device for use in one or more application domains, these domains comprising, but not limited to, city wearable technology, extended industrial application, and healthcare. Non-limiting examples of such an IoT device are a device which is or which is embedded in: a connected refrigerator or freezer, a television, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or VR, a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an ToT device comprises circuitry and/or software in dependence of the intended application of the IoT device in addition to other components as described in relation to the UE 400 shown in FIG. 4.

As yet another specific example, in an IoT scenario, a UE may represent a machine or other device that performs monitoring and/or measurements and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship, an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator and handle communication of data for both the speed sensor and the actuators.

FIG. 5 shows a network node 500 in accordance with some embodiments. As used herein, network node refers to equipment capable, configured, arranged, and/or operable to communicate directly or indirectly with a UE and/or with other network nodes or equipment in a telecommunication network. Examples of network nodes include, but are not limited to, APs (e.g., radio APs), Base Stations (BSs) (e.g., radio BSs, Node Bs, evolved Node Bs (eNBs), NR Node Bs (gNBs)), and O-RAN nodes or components of an O-RAN node (e.g., O-RU, O-DU, O-CU).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units, distributed units (e.g., in an O-RAN access node), and/or Remote Radio Units (RRUs), sometimes referred to as Remote Radio Heads (RRHs). Such RRUs may or may not be integrated with an antenna as an antenna integrated radio. Parts of a distributed radio base station may also be referred to as nodes in a Distributed Antenna System (DAS).

Other examples of network nodes include multiple Transmission Point (multi-TRP) 5G access nodes, Multi-Standard Radio (MSR) equipment such as MSR BSs, network controllers such as Radio Network Controllers (RNCs) or BS Controllers (BSCs), Base Transceiver Stations (BTSs), transmission points, transmission nodes, Multi-Cell/Multicast Coordination Entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 500 includes processing circuitry 502, memory 504, a communication interface 506, and a power source 508. The network node 500 may be composed of multiple physically separate components (e.g., a NodeB component and an RNC component, or a BTS component and a BSC component, etc.), which may each have their own respective components. In certain scenarios in which the network node 500 comprises multiple separate components (e.g., BTS and BSC components), one or more of the separate components may be shared among several network nodes. For example, a single RNC may control multiple NodeBs. In such a scenario, each unique NodeB and RNC pair may in some instances be considered a single separate network node. In some embodiments, the network node 500 may be configured to support multiple RATs. In such embodiments, some components may be duplicated (e.g., separate memory 504 for different RATs) and some components may be reused (e.g., a same antenna 510 may be shared by different RATs). The network node 500 may also include multiple sets of the various illustrated components for different wireless technologies integrated into network node 500, for example GSM, WCDMA, LTE, NR, WiFi, Zigbee, Z-wave, Long Range Wide Area Network (LoRaWAN), Radio Frequency Identification (RFID), or Bluetooth wireless technologies. These wireless technologies may be integrated into the same or different chip or set of chips and other components within the network node 500.

The processing circuitry 502 may comprise a combination of one or more of a microprocessor, controller, microcontroller, CPU, DSP, ASIC, FPGA, or any other suitable computing device, resource, or combination of hardware, software, and/or encoded logic operable to provide, either alone or in conjunction with other network node 500 components, such as the memory 504, to provide network node 500 functionality.

In some embodiments, the processing circuitry 502 includes a System on a Chip (SOC). In some embodiments, the processing circuitry 502 includes one or more of Radio Frequency (RF) transceiver circuitry 512 and baseband processing circuitry 514. In some embodiments, the RF transceiver circuitry 512 and the baseband processing circuitry 514 may be on separate chips (or sets of chips), boards, or units, such as radio units and digital units. In alternative embodiments, part or all of the RF transceiver circuitry 512 and the baseband processing circuitry 514 may be on the same chip or set of chips, boards, or units.

The memory 504 may comprise any form of volatile or non-volatile computer-readable memory including, without limitation, persistent storage, solid state memory, remotely mounted memory, magnetic media, optical media, RAM, ROM, mass storage media (for example, a hard disk), removable storage media (for example, a flash drive, a Compact Disk (CD), or a Digital Video Disk (DVD)), and/or any other volatile or non-volatile, non-transitory device-readable, and/or computer-executable memory devices that store information, data, and/or instructions that may be used by the processing circuitry 502. The memory 504 may store any suitable instructions, data, or information, including a computer program, software, an application including one or more of logic, rules, code, tables, and/or other instructions capable of being executed by the processing circuitry 502 and utilized by the network node 500. The memory 504 may be used to store any calculations made by the processing circuitry 502 and/or any data received via the communication interface 506. In some embodiments, the processing circuitry 502 and the memory 504 are integrated.

The communication interface 506 is used in wired or wireless communication of signaling and/or data between a network node, access network, and/or UE. As illustrated, the communication interface 506 comprises port(s)/terminal(s) 516 to send and receive data, for example to and from a network over a wired connection. The communication interface 506 also includes radio front-end circuitry 518 that may be coupled to, or in certain embodiments a part of, the antenna 510. The radio front-end circuitry 518 comprises filters 520 and amplifiers 522. The radio front-end circuitry 518 may be connected to the antenna 510 and the processing circuitry 502. The radio front-end circuitry 518 may be configured to condition signals communicated between the antenna 510 and the processing circuitry 502. The radio front-end circuitry 518 may receive digital data that is to be sent out to other network nodes or UEs via a wireless connection. The radio front-end circuitry 518 may convert the digital data into a radio signal having the appropriate channel and bandwidth parameters using a combination of the filters 520 and/or the amplifiers 522. The radio signal may then be transmitted via the antenna 510. Similarly, when receiving data, the antenna 510 may collect radio signals which are then converted into digital data by the radio front-end circuitry 518. The digital data may be passed to the processing circuitry 502. In other embodiments, the communication interface 506 may comprise different components and/or different combinations of components.

In certain alternative embodiments, the network node 500 does not include separate radio front-end circuitry 518; instead, the processing circuitry 502 includes radio front-end circuitry and is connected to the antenna 510. Similarly, in some embodiments, all or some of the RF transceiver circuitry 512 is part of the communication interface 506. In still other embodiments, the communication interface 506 includes the one or more ports or terminals 516, the radio front-end circuitry 518, and the RF transceiver circuitry 512 as part of a radio unit (not shown), and the communication interface 506 communicates with the baseband processing circuitry 514, which is part of a digital unit (not shown).

The antenna 510 may include one or more antennas, or antenna arrays, configured to send and/or receive wireless signals. The antenna 510 may be coupled to the radio front-end circuitry 518 and may be any type of antenna capable of transmitting and receiving data and/or signals wirelessly. In certain embodiments, the antenna 510 is separate from the network node 500 and connectable to the network node 500 through an interface or port.

The antenna 510, the communication interface 506, and/or the processing circuitry 502 may be configured to perform any receiving operations and/or certain obtaining operations described herein as being performed by the network node 500. Any information, data, and/or signals may be received from a UE, another network node, and/or any other network equipment. Similarly, the antenna 510, the communication interface 506, and/or the processing circuitry 502 may be configured to perform any transmitting operations described herein as being performed by the network node 500. Any information, data, and/or signals may be transmitted to a UE, another network node, and/or any other network equipment.

The power source 508 provides power to the various components of the network node 500 in a form suitable for the respective components (e.g., at a voltage and current level needed for each respective component). The power source 508 may further comprise, or be coupled to, power management circuitry to supply the components of the network node 500 with power for performing the functionality described herein. For example, the network node 500 may be connectable to an external power source (e.g., the power grid or an electricity outlet) via input circuitry or an interface such as an electrical cable, whereby the external power source supplies power to power circuitry of the power source 508. As a further example, the power source 508 may comprise a source of power in the form of a battery or battery pack which is connected to, or integrated in, power circuitry. The battery may provide backup power should the external power source fail.

Embodiments of the network node 500 may include additional components beyond those shown in FIG. 5 for providing certain aspects of the network node's functionality, including any of the functionality described herein and/or any functionality necessary to support the subject matter described herein. For example, the network node 500 may include user interface equipment to allow input of information into the network node 500 and to allow output of information from the network node 500. This may allow a user to perform diagnostic, maintenance, repair, and other administrative functions for the network node 500.

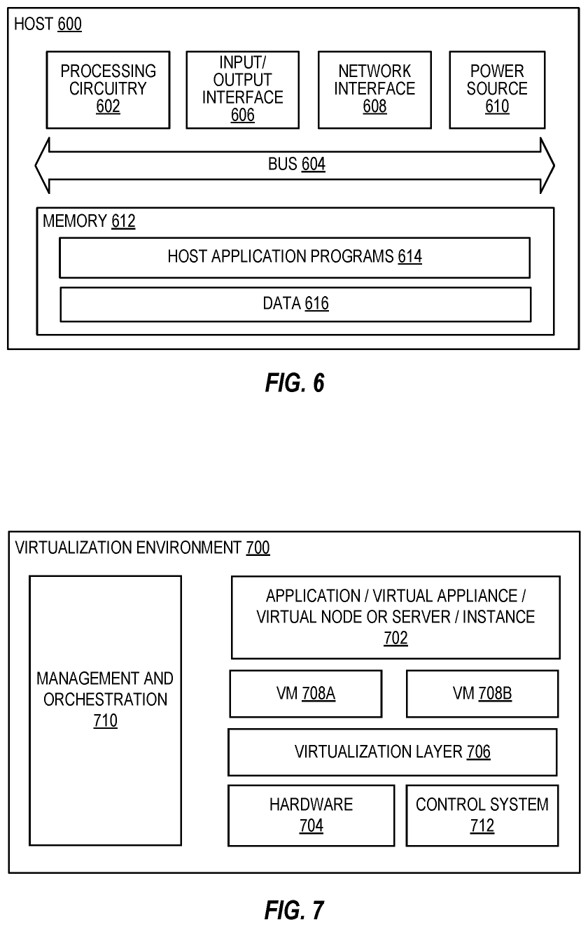

FIG. 6 is a block diagram of a host 600, which may be an embodiment of the host 316 of FIG. 3, in accordance with various aspects described herein. As used herein, the host 600 may be or comprise various combinations of hardware and/or software including a standalone server, a blade server, a cloud-implemented server, a distributed server, a virtual machine, container, or processing resources in a server farm. The host 600 may provide one or more services to one or more UEs.

The host 600 includes processing circuitry 602 that is operatively coupled via a bus 604 to an input/output interface 606, a network interface 608, a power source 610, and memory 612. Other components may be included in other embodiments. Features of these components may be substantially similar to those described with respect to the devices of previous figures, such as FIGS. 4 and 5, such that the descriptions thereof are generally applicable to the corresponding components of the host 600.

The memory 612 may include one or more computer programs including one or more host application programs 614 and data 616, which may include user data, e.g. data generated by a UE for the host 600 or data generated by the host 600 for a UE. Embodiments of the host 600 may utilize only a subset or all of the components shown. The host application programs 614 may be implemented in a container-based architecture and may provide support for video codecs (e.g., Versatile Video Coding (VVC), High Efficiency Video Coding (HEVC), Advanced Video Coding (AVC), Moving Picture Experts Group (MPEG), VP9) and audio codecs (e.g., Free Lossless Audio Codec (FLAC), Advanced Audio Coding (AAC), MPEG, G.711), including transcoding for multiple different classes, types, or implementations of UEs (e.g., handsets, desktop computers, wearable display systems, and heads-up display systems). The host application programs 614 may also provide for user authentication and licensing checks and may periodically report health, routes, and content availability to a central node, such as a device in or on the edge of a core network. Accordingly, the host 600 may select and/or indicate a different host for Over-The-Top (OTT) services for a UE. The host application programs 614 may support various protocols, such as the HTTP Live Streaming (HLS) protocol, Real-Time Messaging Protocol (RTMP), Real-Time Streaming Protocol (RTSP), Dynamic Adaptive Streaming over HTTP (DASH or MPEG-DASH), etc.

FIG. 7 is a block diagram illustrating a virtualization environment 700 in which functions implemented by some embodiments may be virtualized. In the present context, virtualizing means creating virtual versions of apparatuses or devices which may include virtualizing hardware platforms, storage devices, and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more Virtual Machines (VMs) implemented in one or more virtual environments 700 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized. In some embodiments, the virtualization environment 700 includes components defined by the O-RAN Alliance, such as an O-Cloud environment orchestrated by a Service Management and Orchestration Framework via an 0-2 interface.

Applications 702 (which may alternatively be called software instances, virtual appliances, network functions, virtual nodes, virtual network functions, etc.) are run in the virtualization environment 700 to implement some of the features, functions, and/or benefits of some of the embodiments disclosed herein.

Hardware 704 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 706 (also referred to as hypervisors or VM Monitors (VMMs)), provide VMs 708A and 708B (one or more of which may be generally referred to as VMs 708), and/or perform any of the functions, features, and/or benefits described in relation with some embodiments described herein. The virtualization layer 706 may present a virtual operating platform that appears like networking hardware to the VMs 708.

The VMs 708 comprise virtual processing, virtual memory, virtual networking, or interface and virtual storage, and may be run by a corresponding virtualization layer 706. Different embodiments of the instance of a virtual appliance 702 may be implemented on one or more of the VMs 708, and the implementations may be made in different ways. Virtualization of the hardware is in some contexts referred to as Network Function Virtualization (NFV). NFV may be used to consolidate many network equipment types onto industry standard high volume server hardware, physical switches, and physical storage, which can be located in data centers and customer premise equipment.

In the context of NFV, a VM 708 may be a software implementation of a physical machine that runs programs as if they were executing on a physical, non-virtualized machine. Each of the VMs 708, and that part of the hardware 704 that executes that VM, be it hardware dedicated to that VM and/or hardware shared by that VM with others of the VMs 708, forms separate virtual network elements. Still in the context of NFV, a virtual network function is responsible for handling specific network functions that run in one or more VMs 708 on top of the hardware 704 and corresponds to the application 702.

The hardware 704 may be implemented in a standalone network node with generic or specific components. The hardware 704 may implement some functions via virtualization. Alternatively, the hardware 704 may be part of a larger cluster of hardware (e.g., such as in a data center or CPE) where many hardware nodes work together and are managed via management and orchestration 710, which, among others, oversees lifecycle management of the applications 702. In some embodiments, the hardware 704 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a RAN or a base station. In some embodiments, some signaling can be provided with the use of a control system 712 which may alternatively be used for communication between hardware nodes and radio units.

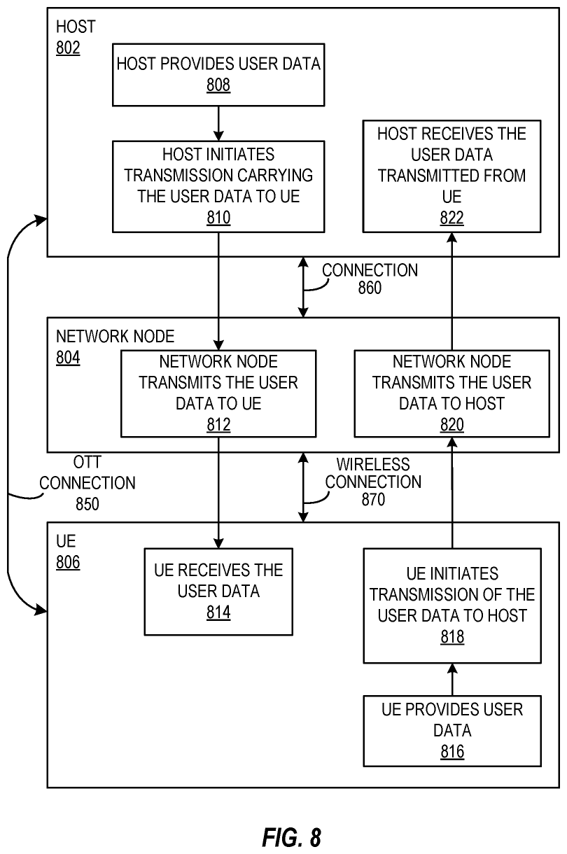

FIG. 8 shows a communication diagram of a host 802 communicating via a network node 804 with a UE 806 over a partially wireless connection in accordance with some embodiments. Example implementations, in accordance with various embodiments, of the UE (such as the UE 312A of FIG. 3 and/or the UE 400 of FIG. 4), the network node (such as the network node 310A of FIG. 3 and/or the network node 500 of FIG. 5), and the host (such as the host 316 of FIG. 3 and/or the host 600 of FIG. 6) discussed in the preceding paragraphs will now be described with reference to FIG. 8.

Like the host 600, embodiments of the host 802 include hardware, such as a communication interface, processing circuitry, and memory. The host 802 also includes software, which is stored in or is accessible by the host 802 and executable by the processing circuitry. The software includes a host application that may be operable to provide a service to a remote user, such as the UE 806 connecting via an OTT connection 850 extending between the UE 806 and the host 802. In providing the service to the remote user, a host application may provide user data which is transmitted using the OTT connection 850.

The network node 804 includes hardware enabling it to communicate with the host 802 and the UE 806. The connection 860 may be direct or pass through a core network (like the core network 306 of FIG. 3) and/or one or more other intermediate networks, such as one or more public, private, or hosted networks. For example, an intermediate network may be a backbone network or the Internet.

The UE 806 includes hardware and software, which is stored in or accessible by the UE 806 and executable by the UE's processing circuitry. The software includes a client application, such as a web browser or operator-specific “app” that may be operable to provide a service to a human or non-human user via the UE 806 with the support of the host 802. In the host 802, an executing host application may communicate with the executing client application via the OTT connection 850 terminating at the UE 806 and the host 802. In providing the service to the user, the UE's client application may receive request data from the host's host application and provide user data in response to the request data. The OTT connection 850 may transfer both the request data and the user data. The UE's client application may interact with the user to generate the user data that it provides to the host application through the OTT connection 850.

The OTT connection 850 may extend via the connection 860 between the host 802 and the network node 804 and via a wireless connection 870 between the network node 804 and the UE 806 to provide the connection between the host 802 and the UE 806. The connection 860 and the wireless connection 870, over which the OTT connection 850 may be provided, have been drawn abstractly to illustrate the communication between the host 802 and the UE 806 via the network node 804, without explicit reference to any intermediary devices and the precise routing of messages via these devices.

As an example of transmitting data via the OTT connection 850, in step 808, the host 802 provides user data, which may be performed by executing a host application. In some embodiments, the user data is associated with a particular human user interacting with the UE 806. In other embodiments, the user data is associated with a UE 806 that shares data with the host 802 without explicit human interaction. In step 810, the host 802 initiates a transmission carrying the user data towards the UE 806. The host 802 may initiate the transmission responsive to a request transmitted by the UE 806. The request may be caused by human interaction with the UE 806 or by operation of the client application executing on the UE 806. The transmission may pass via the network node 804 in accordance with the teachings of the embodiments described throughout this disclosure. Accordingly, in step 812, the network node 804 transmits to the UE 806 the user data that was carried in the transmission that the host 802 initiated, in accordance with the teachings of the embodiments described throughout this disclosure. In step 814, the UE 806 receives the user data carried in the transmission, which may be performed by a client application executed on the UE 806 associated with the host application executed by the host 802.

In some examples, the UE 806 executes a client application which provides user data to the host 802. The user data may be provided in reaction or response to the data received from the host 802. Accordingly, in step 816, the UE 806 may provide user data, which may be performed by executing the client application. In providing the user data, the client application may further consider user input received from the user via an input/output interface of the UE 806. Regardless of the specific manner in which the user data was provided, the UE 806 initiates, in step 818, transmission of the user data towards the host 802 via the network node 804. In step 820, in accordance with the teachings of the embodiments described throughout this disclosure, the network node 804 receives user data from the UE 806 and initiates transmission of the received user data towards the host 802. In step 822, the host 802 receives the user data carried in the transmission initiated by the UE 806.

One or more of the various embodiments improve the performance of OTT services provided to the UE 806 using the OTT connection 850, in which the wireless connection 870 forms the last segment. More precisely, the teachings of these embodiments may improve the e.g., data rate, latency, power consumption, etc. and thereby provide benefits such as e.g., reduced user waiting time, relaxed restriction on file size, improved content resolution, better responsiveness, extended battery lifetime, etc.

In an example scenario, factory status information may be collected and analyzed by the host 802. As another example, the host 802 may process audio and video data which may have been retrieved from a UE for use in creating maps. As another example, the host 802 may collect and analyze real-time data to assist in controlling vehicle congestion (e.g., controlling traffic lights). As another example, the host 802 may store surveillance video uploaded by a UE. As another example, the host 802 may store or control access to media content such as video, audio, VR, or AR which it can broadcast, multicast, or unicast to UEs. As other examples, the host 802 may be used for energy pricing, remote control of non-time critical electrical load to balance power generation needs, location services, presentation services (such as compiling diagrams etc. from data collected from remote devices), or any other function of collecting, retrieving, storing, analyzing, and/or transmitting data.

In some examples, a measurement procedure may be provided for the purpose of monitoring data rate, latency, and other factors on which the one or more embodiments improve. There may further be an optional network functionality for reconfiguring the OTT connection 850 between the host 802 and the UE 806 in response to variations in the measurement results. The measurement procedure and/or the network functionality for reconfiguring the OTT connection 850 may be implemented in software and hardware of the host 802 and/or the UE 806. In some embodiments, sensors (not shown) may be deployed in or in association with other devices through which the OTT connection 850 passes; the sensors may participate in the measurement procedure by supplying values of the monitored quantities exemplified above, or by supplying values of other physical quantities from which software may compute or estimate the monitored quantities. The reconfiguring of the OTT connection 850 may include message format, retransmission settings, preferred routing, etc.; the reconfiguring need not directly alter the operation of the network node 804. Such procedures and functionalities may be known and practiced in the art. In certain embodiments, measurements may involve proprietary UE signaling that facilitates measurements of throughput, propagation times, latency, and the like by the host 802. The measurements may be implemented in that software causes messages to be transmitted, in particular empty or ‘dummy’ messages, using the OTT connection 850 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions, and methods disclosed herein. Determining, calculating, obtaining, or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box or nested within multiple boxes, in practice computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hardwired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole and/or by end users and a wireless network generally.

Those skilled in the art will recognize improvements and modifications to the embodiments of the present disclosure. All such improvements and modifications are considered within the scope of the concepts disclosed herein.

### Embodiments

### Group A Embodiments

Embodiment 1: A method performed by a user equipment for evaluating candidate beam pair links, the method comprising one or more of: a. indicating support for “probing uplink, UL, reference signal, RS” during capability signalling; b. determining the spatial filter for the UL-RS transmission based on a group of DL reference signals (e.g., SSBs, CSI-RS or new DL-RS for 6G); c. updating the spatial relation of an UL-RS; and d. transmitting UL-RS directly without a need of explicit spatial relation update for the UL-RS from a network node (e.g., gNB).

Embodiment 2: The method of the previous embodiment wherein updating the spatial relation is in response to receiving a request from the network node.

Embodiment 3: The method of any of the previous embodiments wherein the UL-RS is an SRS.

Embodiment 4: The method of any of the previous embodiments wherein the indication of the support for “probing UL-RS” during capability signalling, indicates one or more of the following information: Periodic, aperiodic and/or semi-persistent transmission of the (probing) UL-RS; Support of UE initiated transmission of the UL-RS; SSB based monitoring for trigger condition for UL-RS transmission; CSI-RS based monitoring for trigger condition for UL-RS transmission; “Other DL-RS in for 6G”-based monitoring for trigger condition for UL-RS transmission; DL-RS based monitoring of spatial filter determination of UL-RS transmission; SSB based monitoring for determining spatial filter for UL-RS transmission; CSI-RS based monitoring for determining spatial filter for UL-RS transmission; “Other DL-RS in for 6G” based monitoring for determining spatial filter for UL-RS transmission; UL-RS transmission from multiple UE panels (“panel sweeping”, i.e., where the UE is mandated to transmit UL-RS from more than one UE panel, to evaluate candidate beam pair links in multiple different directions seen from the UE); Number of panels to sweep through; Support of simultaneously transmitting from maximum X number of panels; UL-RS transmission in different UE beams (“beam sweeping”, i.e., where the UE is mandated to transmit UL-RS from more than one UE beam, to evaluate candidate beam pair links in multiple different directions seen from the UE); Preferred number of UE beams to sweep through (can for example be based on how many narrow beams the UE has per UE panel); UL-RS transmission from autonomously selected UE panel; Based on power headroom, SAR (specific absorption rate), antenna distribution that is known better at the UE side.

Embodiment 5: The method of any of the previous embodiments wherein the DL-RSs are based on two or more DL-RSs.

Embodiment 6: The method of any of the previous embodiments wherein, which DL-RSs (e.g., a group of SSBs) the UE shall use to determine the relevant spatial filter is configured by the network.

Embodiment 7: The method of any of the previous embodiments wherein all the cell-defining SSBs indicated to the UE during initial access, are used by default (e.g., unless other dedicated configuration has been signaled).

Embodiment 8: The method of any of the previous embodiments wherein the method also includes transmitting the probing UL-RS with a spatial filter associated with a DL-RS that is received with strongest RSRP out of the configured groups of DL-RSs.

Embodiment 9: The method of any of the previous embodiments wherein the method also includes: transmitting the probing UL-RS with a spatial filter associated with one DL-RS that is one of the DL-RSs received with strongest RSRP out of the configured groups of DL-RSs.

Embodiment 10: The method of any of the previous embodiments wherein the method also includes: deciding which one DL-RS to be used to determine the spatial filter to be used to transmit the probing UL-RS.

Embodiment 11: The method of any of the previous embodiments wherein if the UE is equipped with multiple panels, which panel to transmit the probing UL-RS from is determined by the UE.

Embodiment 12: The method of any of the previous embodiments wherein the UE is configured to transmit probing UL-RSs from multiple different panels.

Embodiment 13: The method of any of the previous embodiments wherein the probing UL-RS transmission can be event-triggered by the UE.

Embodiment 14: The method of any of the previous embodiments, further comprising: providing user data; and forwarding the user data to a host via the transmission to the network node.

### Group B Embodiments

Embodiment 15: A method performed by a network node for evaluating candidate beam pair links, the method comprising: a. receiving an indication regarding support for “probing uplink, UL, reference signal, RS” during capability signalling; b. determining the spatial filter for the UL-RS transmission based on a group of DL reference signals (e.g., SSBs, CSI-RS or new DL-RS for 6G); c. receiving an UL-RS directly without a need of explicit spatial relation update for the UL-RS from the network node (e.g., gNB); and d. updating the spatial relation of an UL-RS.

Embodiment 16: The method of the previous embodiment wherein updating the spatial relation is in response to receiving a request from the network node.

Embodiment 17: The method of any of the previous embodiments wherein the UL-RS is an SRS.

Embodiment 18: The method of any of the previous embodiments wherein the indication of the support for “probing UL-RS” during capability signalling, indicates one or more of the following information: Periodic, aperiodic and/or semi-persistent transmission of the (probing) UL-RS; Support of UE initiated transmission of the UL-RS; SSB based monitoring for trigger condition for UL-RS transmission; CSI-RS based monitoring for trigger condition for UL-RS transmission; “Other DL-RS in for 6G”-based monitoring for trigger condition for UL-RS transmission; DL-RS based monitoring of spatial filter determination of UL-RS transmission; SSB based monitoring for determining spatial filter for UL-RS transmission; CSI-RS based monitoring for determining spatial filter for UL-RS transmission; “Other DL-RS in for 6G” based monitoring for determining spatial filter for UL-RS transmission; UL-RS transmission from multiple UE panels (“panel sweeping”, i.e., where the UE is mandated to transmit UL-RS from more than one UE panel, to evaluate candidate beam pair links in multiple different directions seen from the UE); Number of panels to sweep through; Support of simultaneously transmitting from maximum X number of panels; UL-RS transmission in different UE beams (“beam sweeping”, i.e., where the UE is mandated to transmit UL-RS from more than one UE beam, to evaluate candidate beam pair links in multiple different directions seen from the UE); Preferred number of UE beams to sweep through (can for example be based on how many narrow beams the UE has per UE panel); UL-RS transmission from autonomously selected UE panel; Based on power headroom, SAR (specific absorption rate), antenna distribution that is known better at the UE side.

Embodiment 19: The method of any of the previous embodiments wherein the DL-RSs are based on two or more DL-RSs.

Embodiment 20: The method of any of the previous embodiments wherein, which DL-RSs (e.g., a group of SSBs) the UE shall use to determine the relevant spatial filter is configured by the network.

Embodiment 21: The method of any of the previous embodiments wherein all the cell-defining SSBs indicated to the UE during initial access, are used by default (e.g., unless other dedicated configuration has been signaled).

Embodiment 22: The method of any of the previous embodiments wherein the method also includes transmitting the probing UL-RS with a spatial filter associated with a DL-RS that is received with strongest RSRP out of the configured groups of DL-RSs.

Embodiment 23: The method of any of the previous embodiments wherein the method also includes: transmitting the probing UL-RS with a spatial filter associated with one DL-RS that is one of the DL-RSs received with strongest RSRP out of the configured groups of DL-RSs.

Embodiment 24: The method of any of the previous embodiments wherein the method also includes: deciding which one DL-RS to be used to determine the spatial filter to be used to transmit the probing UL-RS.

Embodiment 25: The method of any of the previous embodiments wherein if the UE is equipped with multiple panels, which panel to transmit the probing UL-RS from is determined by the UE.

Embodiment 26: The method of any of the previous embodiments wherein the UE is configured to transmit probing UL-RSs from multiple different panels.

Embodiment 27: The method of any of the previous embodiments wherein the probing UL-RS transmission can be event-triggered by the UE.

Embodiment 28: The method of any of the previous embodiments, further comprising: obtaining user data; and forwarding the user data to a host or a user equipment.

### Group C Embodiments

Embodiment 29: A user equipment for evaluating candidate beam pair links, comprising: processing circuitry configured to perform any of the steps of any of the Group A embodiments; and power supply circuitry configured to supply power to the processing circuitry.

Embodiment 30: A network node for evaluating candidate beam pair links, the network node comprising: processing circuitry configured to perform any of the steps of any of the Group B embodiments; and power supply circuitry configured to supply power to the processing circuitry.

Embodiment 31: A user equipment (UE) for evaluating candidate beam pair links, the UE comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of the Group A embodiments; an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.

Embodiment 32: A host configured to operate in a communication system to provide an over-the-top (OTT) service, the host comprising: processing circuitry configured to provide user data; and a network interface configured to initiate transmission of the user data to a network node in a cellular network for transmission to a user equipment (UE), the network node having a communication interface and processing circuitry, the processing circuitry of the network node configured to perform any of the operations of any of the Group B embodiments to transmit the user data from the host to the UE.

Embodiment 33: The host of the previous embodiment, wherein: the processing circuitry of the host is configured to execute a host application that provides the user data; and the UE comprises processing circuitry configured to execute a client application associated with the host application to receive the transmission of user data from the host.

Embodiment 34: A method implemented in a host configured to operate in a communication system that further includes a network node and a user equipment (UE), the method comprising: providing user data for the UE; and initiating a transmission carrying the user data to the UE via a cellular network comprising the network node, wherein the network node performs any of the operations of any of the Group B embodiments to transmit the user data from the host to the UE.

Embodiment 35: The method of the previous embodiment, further comprising, at the network node, transmitting the user data provided by the host for the UE.

Embodiment 36: The method of any of the previous 2 embodiments, wherein the user data is provided at the host by executing a host application that interacts with a client application executing on the UE, the client application being associated with the host application.

Embodiment 37: A communication system configured to provide an over-the-top (OTT) service, the communication system comprising: a host comprising: processing circuitry configured to provide user data for a user equipment (UE), the user data being associated with the over-the-top service; and a network interface configured to initiate transmission of the user data toward a cellular network node for transmission to the UE, the network node having a communication interface and processing circuitry, the processing circuitry of the network node configured to perform any of the operations of any of the Group B embodiments to transmit the user data from the host to the UE.

Embodiment 38: The communication system of the previous embodiment, further comprising: the network node; and/or the UE.

Embodiment 39: A host configured to operate in a communication system to provide an over-the-top (OTT) service, the host comprising: processing circuitry configured to initiate receipt of user data; and a network interface configured to receive the user data from a network node in a cellular network, the network node having a communication interface and processing circuitry, the processing circuitry of the network node configured to perform any of the operations of any of the Group B embodiments to receive the user data from a user equipment (UE) for the host.

Embodiment 40: The host of the previous 2 embodiments, wherein: the processing circuitry of the host is configured to execute a host application that receives the user data; and the host application is configured to interact with a client application executing on the UE, the client application being associated with the host application.

Embodiment 41: The host of the any of the previous 2 embodiments, wherein the initiating receipt of the user data comprises requesting the user data.

Embodiment 42: A method implemented by a host configured to operate in a communication system that further includes a network node and a user equipment (UE), the method comprising: at the host, initiating receipt of user data from the UE, the user data originating from a transmission which the network node has received from the UE, wherein the network node performs any of the steps of any of the Group B embodiments to receive the user data from the UE for the host.

Embodiment 43: The method of the previous embodiment, further comprising at the network node, transmitting the received user data to the host.

Embodiment 44: A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the operations of any of the Group A embodiments to receive the user data from the host.

Embodiment 45: The host of the previous embodiment, wherein the cellular network further includes a network node configured to communicate with the UE to transmit the user data to the UE from the host.

Embodiment 46: The host of the previous 2 embodiments, wherein: the processing circuitry of the host is configured to execute a host application, thereby providing the user data; and the host application is configured to interact with a client application executing on the UE, the client application being associated with the host application.

Embodiment 47: A method implemented by a host operating in a communication system that further includes a network node and a user equipment (UE), the method comprising: providing user data for the UE; and initiating a transmission carrying the user data to the UE via a cellular network comprising the network node, wherein the UE performs any of the operations of any of the Group A embodiments to receive the user data from the host.

Embodiment 48: The method of the previous embodiment, further comprising: at the host, executing a host application associated with a client application executing on the UE to receive the user data from the host application.

Embodiment 49: The method of the previous embodiment, further comprising: at the host, transmitting input data to the client application executing on the UE, the input data being provided by executing the host application, wherein the user data is provided by the client application in response to the input data from the host application.

Embodiment 50: A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A embodiments to transmit the user data to the host.

Embodiment 51: The host of the previous embodiment, wherein the cellular network further includes a network node configured to communicate with the UE to transmit the user data from the UE to the host.

Embodiment 52: The host of the previous 2 embodiments, wherein: the processing circuitry of the host is configured to execute a host application, thereby providing the user data; and the host application is configured to interact with a client application executing on the UE, the client application being associated with the host application.

Embodiment 53: A method implemented by a host configured to operate in a communication system that further includes a network node and a user equipment (UE), the method comprising: at the host, receiving user data transmitted to the host via the network node by the UE, wherein the UE performs any of the steps of any of the Group A embodiments to transmit the user data to the host.

Embodiment 54: The method of the previous embodiment, further comprising: at the host, executing a host application associated with a client application executing on the UE to receive the user data from the UE.

Embodiment 55: The method of the previous 2 embodiments, further comprising: at the host, transmitting input data to the client application executing on the UE, the input data being provided by executing the host application, wherein the user data is provided by the client application in response to the input data from the host application.

1. A method performed by a User Equipment (UE) for evaluating candidate beam pair links, the method comprising:
indicating support for probing an Uplink (UL) reference signal (RS) (UL) during capability signaling;
determining a spatial filter for a UL-RS transmission based on one or more Downlink (DL) Reference Signals (DL-R Ss);
updating a spatial relation of the UL-RS; and
transmitting the UL-RS using the spatial filter without a need of explicit spatial relation update for the UL-RS from a network node.

2. The method of claim 1, wherein the UL-RS is one of a Sounding Reference Signal (SRS) and a new UL-RS for Sixth Generation (6G).

3. The method of claim 1, wherein the one or more DL-RSs comprise one or more of: Synchronization Signal Blocks (SSBs); Channel State Information—Reference Signal (CSI-RS); and new DL-RSs for 6G.

4. The method of claim 1, wherein the indication of the support for probing UL-RS during capability signaling indicates one or more of the following information:
support of periodic, aperiodic and/or semi-persistent transmission of the (probing) UL-RS;
support of UE initiated transmission of the UL-RS;
support of SSB based monitoring for trigger condition for UL-RS transmission;
support of CSI-RS based monitoring for trigger condition for UL-RS transmission;
support of DL-RS based monitoring for trigger condition for UL-RS transmission;
support of DL-RS based monitoring of spatial filter determination of UL-RS transmission;
support of SSB based monitoring for determining spatial filter for UL-RS transmission;
support of CSI-RS based monitoring for determining spatial filter for UL-RS transmission;
support of UL-RS transmission from multiple UE panels;
support of a number of panels to sweep through;
support of simultaneously transmitting from maximum X number of panels;
support of UL-RS transmission in different UE beams;
a preferred number of UE beams to sweep through; and
support of UL-RS transmission from autonomously selected UE panel.

5. The method of claim 1, wherein which DL-RSs the UE shall use to determine the relevant spatial filter is configured by the network.

6. The method of claim 1, wherein all the cell-defining SSBs indicated to the UE during initial access are used by default to determine the relevant spatial filter.

7. The method of claim 1, further comprising:
transmitting the probing UL-RS with a spatial filter associated with a DL-RS that is received with strongest Reference Signal Received Power (RSRP) and/or Layer 1 Signal to Interference plus Noise Ratio (L1-SINR) out of the configured groups of DL-RSs.

8. The method of claim 1, further comprising:
transmitting the probing UL-RS with a spatial filter associated with one DL-RS that is one of the DL-RSs received with strongest RSRP and/or L1-SINR out of the configured groups of DL-RSs.

9. The method of claim 1, further comprising:
deciding which one DL-RS to be used to determine the spatial filter to be used to transmit the probing UL-RS.

10. The method of claim 1, wherein, if the UE is equipped with multiple panels, which panel to transmit the probing UL-RS from is determined by the UE.

11. The method of claim 1, wherein the UE is configured to transmit probing UL-RSs from multiple different panels.

12. The method of claim 1, wherein the probing UL-RS transmission is event-triggered by the UE.

13. The method of claim 1, wherein the network node comprises a gNB.

14. A method performed by a network node for evaluating candidate beam pair links, the method comprising:
receiving, from a User Equipment (UE) an indication regarding support for probing uplink (UL) reference signal (RS) (UL-RS) during capability signaling;
receiving a UL-RS directly without a need of explicit spatial relation update for the UL-RS from the network node;
deriving a spatial source RS for the spatial relation of the received UL-RS; and
updating the spatial relation of a UL-RS.

15. The method of claim 14, wherein the UL-RS is one of a Sounding Reference Signal (SRS) and a new UL-RS for Sixth Generation (6G).

16. The method of claim 14, wherein one or more downlink (DL) reference signals (DL-RSs) comprise one or more of: Synchronization Signal Blocks (SSBs); Channel State Information—Reference Signal (CSI-RS); and a new DL-RS for 6G.

17. The method of claim 14, wherein the indication of the support for probing UL-RS during capability signaling indicates one or more of the following information:
support of periodic, aperiodic and/or semi-persistent transmission of the (probing) UL-RS;
support of UE initiated transmission of the UL-RS;
support of SSB based monitoring for trigger condition for UL-RS transmission;
support of CSI-RS based monitoring for trigger condition for UL-RS transmission;
support of DL-RS based monitoring for trigger condition for UL-RS transmission;
support of DL-RS based monitoring of spatial filter determination of UL-RS transmission;
support of SSB based monitoring for determining spatial filter for UL-RS transmission;
support of CSI-RS based monitoring for determining spatial filter for UL-RS transmission;
support of UL-RS transmission from multiple UE panels;
support of a number of panels to sweep through;
support of simultaneously transmitting from maximum X number of panels;
support of UL-RS transmission in different UE beams;
a preferred number of UE beams to sweep through; and
support of UL-RS transmission from autonomously selected UE panel.

18. The method of claim 14, wherein which DL-RSs the UE shall use to determine the relevant spatial filter is configured by the network.

19-26. (canceled)

27. A User Equipment (UE) for evaluating candidate beam pair links, the UE comprising processing circuitry and memory, the memory comprising instructions to cause the UE to:
indicate support for probing Uplink (UL) reference signal (RS) (UL-RS) during capability signaling;
determine a spatial filter for a UL-RS transmission based on one or more Downlink (DL) Reference Signals (DL-RSs);
update a spatial relation of the UL-RS; and
transmit the UL-RS using the spatial filter without a need of explicit spatial relation update for the UL-RS from a network node.

28. (canceled)

29. A network node for evaluating candidate beam pair links, the network node comprising processing circuitry and memory, the memory comprising instructions to cause the network node to:
receive, from a User Equipment (UE) an indication regarding support for probing an uplink (UL) reference signal (RS) (UL-RS) during capability signaling;
receive a UL-RS directly without a need of explicit spatial relation update for the UL-RS from the network node;
derive a spatial source RS for the spatial relation of the received UL-RS; and
update the spatial relation of a UL-RS.

30-32. (canceled)
